(19) United States
(12) Patent Application Publication
(10) Pub. No.: US 2024/0070791 A1
(43) Pub. Date: Feb. 29, 2024

(54) RE100 ENERGY TRANSACTION SYSTEM AND METHOD USING BLOCKCHAIN

(71) Applicant: Kepco KDN Co., Ltd., Jeollanam-do (KR)

(72) Inventors: Su Mi JEONG, Jeollanam-do (KR); Chong Tai PARK, Gwangju (KR)

(73) Assignee: Kepco KDN Co., Ltd., Jeollanam-do (KR)

(21) Appl. No.: 18/268,633

(22) PCT Filed: Jan. 20, 2021
(86) PCT No.: PCT/KR2021/095006

§ 371 Date: Jun. 21, 2023

(30) Foreign Application Priority Data
Dec. 21, 2020 (KR) 10-2020-0179784

(51) Int. Cl. G06Q 50/06; G06Q 20/38

(52) U.S. Cl. CPC G06Q 50/06; G06Q 20/3821; G06Q 20/389

(57) ABSTRACT

According to an embodiment, an RE100 energy transaction system using a blockchain is provided, the system comprising: a first blockchain node for generating power production information and sales information according to the production of renewable energy, and sharing the power production information and the sales information with a node participating in a blockchain network; a second blockchain node for generating power purchase information, and sharing the power purchase information with the node participating in the blockchain network; and a certification authority for performing authentication procedures of the first blockchain node and the second blockchain node participating in the blockchain network, wherein the first blockchain node and the second blockchain node store a first blockchain relating to the power production information and the sales information and a second blockchain relating to the power purchase information, and update the first blockchain and the second blockchain when a renewable energy transaction occurs.

### TECHNICAL FIELD

The present invention relates to a RE100 energy transaction system and method using a blockchain.

### BACKGROUND ART

Renewable Energy 100% (RE100) is a campaign that covers 100% of the amount of electricity used by companies using only renewable energy such as solar and wind power. The RE100 campaign is already being implemented overseas, and Google and Apple are successfully powered by 100% renewable energy. Thanks to this trend, the RE100 campaign has begun in Korea, and the Korea Energy Agency and Korea Electric Power Corporation are announcing a pilot project plan for the ‘Renewable Energy Usage Recognition System’, creating a foundation for domestic companies to participate.

In this trend, the demand for the use of new and renewable energy in the market of developed countries for products exported from Korea is expanding, and institutional devices to guarantee that Korean export manufacturers have used new and renewable energy are now being introduced.

In addition, it is necessary to prepare technical, business, and institutional foundations to establish a transparent and fair electricity transaction system that can replace an existing certification system for renewable energy production and consumption.

### DISCLOSURE

### Technical Problem

The technical object to be achieved by the present invention is to provide an RE100 energy transaction system and method using a blockchain that can improve the reliability and security of an RE100 energy transaction.

### Technical Solution

An embodiment provides an RE100 energy transaction system using a blockchain, comprising a first blockchain node that generates power production information and sales information according to production of renewable energy, and shares the power production information and the sales information with a node participating in a blockchain network; a second blockchain node that generates power purchase information, and shares the power purchase information with the node participating in the blockchain network; and a certification authority that performs an authentication procedure of the first and second blockchain nodes participating in the blockchain network, wherein the first blockchain node and the second blockchain node store a first blockchain relating to the power production information and the sales information and a second blockchain relating to the power purchase information, respectively, and update the first blockchain and the second blockchain when a renewable energy transaction occurs.

The certification authority may send a credential to a certified node.

The system may further comprise a management server that receives the credential from the certification authority and manages the node participating in the blockchain network.

The management server may verify reliability of the renewable energy transaction using stored node information when the renewable energy transaction occurs.

The power production information and the sales information may include an owner of a power generator, type of industry, location, type of production energy, total capacity available for production, current production and sales capacity and unit price, production time, production energy power information and grid connection information.

The purchase information may include an owner of a consumption company, type of industry, type of business, production item, location, type and capacity of renewable energy to be purchased, desired purchase price, desired purchase time, and device information.

The first blockchain node and the second blockchain node may generate transaction information when the renewable energy transaction occurs to update the first blockchain and the second blockchain.

The transaction information may include purchase type of renewable energy, purchase amount, purchase meter and GPS location of a business, production time and purchase time.

According to an embodiment, an RE100 energy transaction method using a blockchain may comprise performing, by a certification authority, an authorization procedure of first and second blockchain nodes participating in a blockchain node; generating power production information and sales information according to production of renewable energy and sharing the power production information and the sales information with a node participating in the blockchain network by the first blockchain node; generating power purchase information and sharing the power purchase information with the node participating in the blockchain network by the second blockchain node; and updating the first blockchain node and the second blockchain node by the first blockchain node and the second blockchain node when a renewable energy transaction occurs.

The certification authority may send a credential to a certified node.

The method may further comprise receiving the credential from the certification authority and managing the node participating in the blockchain network by a management server.

The method may further comprise verifying, by the management server, reliability of the renewable energy transaction using stored node information when the renewable energy transaction occurs.

The power production information and the sales information may include an owner of a power generator, type of industry, location, type of production energy, total capacity available for production, current production and sales capacity and unit price, production time, production energy power information and grid connection information.

The purchase information may include an owner of a consumption company, type of industry, type of business, production item, location, type and capacity of renewable energy to be purchased, desired purchase price, desired purchase time, and device information.

The first blockchain node and the second blockchain node may generate transaction information when the renewable energy transaction occurs to update the first blockchain and the second blockchain.

The transaction information may include purchase type of renewable energy, purchase amount, purchase meter and GPS location of a business, production time and purchase time.

According to an embodiment, a computer-readable recording medium storing a program that, when executed by a computer, causes the computer to perform the above-described method is provided.

### Advantageous Effects

The RE100 energy transaction system and method using a blockchain of the present invention can be operated more safely against hacking damage by adopting a distributed storage method.

In addition, a smart contract-based contract is concluded between a renewable energy power generator and an RE100 consumption company, which can block the possibility of mutual manipulation and cheating.

In addition, renewable energy production/sales information and RE100 purchase information are safely distributed and stored in blocks every 15 minutes and transaction results are stored every second, making manipulation by participating parties and third parties impossible.

In addition, using smart contract technology, it is possible to objectively prove whether energy has been traded, and it is possible to be recognized as a reliable system by a third party because post-manipulation is impossible.

In addition, the fairness and security of transactions between renewable energy production and consumption parties can be improved.

### DESCRIPTION OF DRAWINGS

FIG. 1 illustrates a conceptual diagram of an RE100 energy transaction system using a blockchain according to an embodiment.

FIG. 2 illustrates a conceptual diagram of a first blockchain according to an embodiment.

FIG. 3 illustrates a conceptual diagram of a second blockchain according to an embodiment.

FIG. 4 illustrates a flowchart of a RE100 energy transaction method using a blockchain according to an embodiment.

### MODE FOR INVENTION

Hereinafter, preferred embodiments of the present invention will be described in detail with reference to the accompanying drawings.

However, the technical ideas of the present invention may not be limited to some of the exemplary embodiments given but may be embodied by mutually different various forms, and may be used by selectively combining or substituting one or more constituent elements among the exemplary embodiments as long as within the technical ideas of the present invention.

In addition, unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art in the present application.

In addition, terms used in the specification are only provided to illustrate the embodiments and should not be construed as limiting the present invention.

In the specification, a singular form of terms includes plural forms thereof, unless specifically mentioned otherwise, and each of the expressions “at least one of A, B and C (or more than one)” may mean one or more combinations in all the combinations combined by A, B, and C.

In addition, in describing elements of exemplary embodiments of the present invention, terms such as first, second, A, B, (a) and (b) may be used.

These terms may be only used to distinguish one element from another element, and essence, order or sequence of relevant elements will not be limited by these terms.

In addition, words such as “connect”, “coupled” or “accessed” used in describing a relationship between different elements not only may imply a direct physical connection with other elements but also may include “connected”, “coupled” or “accessed” the other elements through intervening elements.

In addition, when an element is referred to as being “on (above)” or “below (under)” another element, it may be directly on (above) or below (under) the other element, or one or more intervening elements may be present between two elements. Thus, the term “on (above)” or “below (under)” can encompass both an orientation of above and below.

Hereinafter, embodiments are described with reference to the attached drawings, and same or corresponding elements regardless of drawing symbols will be given the same reference numbers, and overlapping descriptions will be omitted.

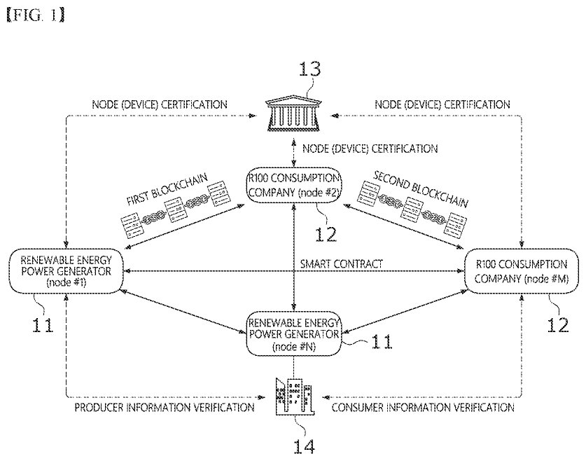

FIG. 1 illustrates a conceptual diagram of an RE100 energy transaction system using a blockchain according to an embodiment.

In an embodiment, an RE100 may refer to a global renewable energy campaign in which an energy producing or consuming enterprise promises to use 100% of the power required for production as renewable energy.

In an embodiment, a node is a computer terminal participating in a blockchain and may refer to a system that functions to calculate a proof of work (PoW) or verify a block by itself.

In an embodiment, smart contact may refer to a method of the decentralized ledger technology, which is used to conclude a transaction automatically between parties if specific conditions for the transaction are satisfied. When transaction conditions and content are registered, relevant laws and procedures corresponding to the contract are applied automatically, and a result of the contract is notified to the transaction parties.

Referring to FIG. 1, an RE100 energy transaction system 10 using a blockchain according to an embodiment may include a first blockchain node 11, a second blockchain node 12, a certification authority 13, and a management server 14.

The first blockchain node 11 may generate power production information and sales information according to the production of renewable energy and share the information with a node participating in the blockchain network.

The first blockchain node 11 may share the power production information and sales information with all nodes participating in the blockchain network and store the information in the first blockchain composed of blocks consented through the blockchain network.

In an embodiment, the first blockchain is a kind of method of storing data in logical sense, and may mean re-hashing a value of a previous access right information hashed by collecting hash values of previous access right information of the previous access right information and information for granting a new access right. In this case, a hash is created to prevent forgery and falsification of contents to be stored, and when storing together with the hash, it may mean that the first blockchain has been generated.

In an embodiment, the server or system of the power generation company that wishes to participate in the RE100 energy transaction becomes the first blockchain node 11 that generates the first blockchain, and each node must be given credential with authorized access to the blockchain network.

Assuming that by comparing information on pre-shared and agreed upon access credentials for the node requesting an access to the blockchain network, a corresponding node has an access right (defined numbers or letters, not virtual currency), the access right may be stored in the first blockchain through a blockchain storage algorithm.

The block verification process is the final step in an access authorization process, and may refer to a process for verifying whether the content of the blockchain to which the access right generated from a specific node has been granted has been stored by other nodes in a device that has no facts of forgery and can be granted access.

The first blockchain is characterized by performing a series of processes of transaction, a proof of work, and incentive, and consecutive blocks generated in this process can be referred to as a blockchain. Blockchains can be stored in association with previous blocks, just as blocks are linked together.

Each first blockchain node 11 may periodically register its power production information and sales information in the first blockchain. In an embodiment, the power production information and sales information may include an owner of a power generator, type of industry, location, type of energy produced, total capacity available for production, current production and sales capacity and unit price, production time, production energy power information, and grid connection information.

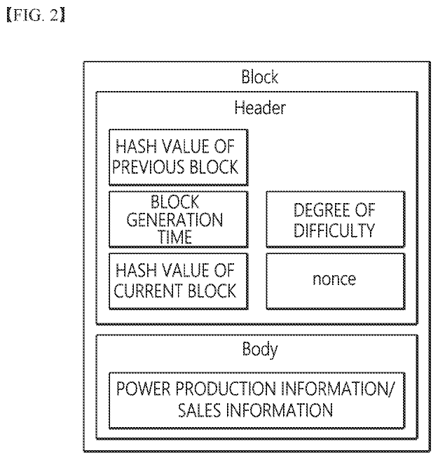

FIG. 2 illustrates a conceptual diagram of a first blockchain according to an embodiment. Referring to FIG. 2, the first blockchain may be divided into a header and a body. The header may include a hash value of a previous block, a block generation time, a degree of difficulty, a result value of a hash function for power production information and sales information, and nonce information. The power production information and the sales information may be stored in the body.

In addition, the first blockchain node 11 may be periodically registered with the power production information and sales information of each first blockchain node 11 and update the first blockchain.

In addition, the first blockchain node 11 may be periodically registered with the purchase information of each second blockchain node 12 and update the second blockchain.

In addition, the first blockchain node 11 may update the first blockchain and the second blockchain using the registered information and provide it to all connected nodes. The first blockchain node 11 may provide the updated blockchain to other nodes in real time when the first blockchain or the second blockchain is updated.

The first blockchain node 11 may ensure the integrity of power production information and sales information by using the first blockchain.

The first blockchain node 11 may transmit the power production information and the sales information to other nodes and store them in the first blockchain through a blockchain network. Through this, the power production information and the sales information may be synchronized for all nodes participating in the blockchain network. The synchronized details are verified by all nodes, and if there are no abnormalities, the block may be completed by consensus. In this case, the node participating to generate the first blockchain may mean all nodes in the blockchain network. Through these procedures, data is shared between nodes on a blockchain network, and transaction records are disclosed transparently, thereby guaranteeing the integrity of power production information and sales information.

For example, the first blockchain node 11 may generate a block using the power production information and sales information received from other nodes. The first blockchain node 11 may generate a block by combining the power production information and the sales information at a specific point in time into one block data.

The first blockchain node 11 may generate a block according to a previously set PoW. That is, the first blockchain node 11 collects the power production information “I sales information” of the nodes in the group, applies PoW to the collected power production information, and generates a block when the PoW is resolved. The block generation time is independent according to the difficulty of PoW and may be different depending on the block. That is, if a degree of difficulty of PoW is high, the block generation time may be delayed, and in this case, other nodes may generate the block first. Also, if the degree of difficulty of PoW is low, the first blockchain node 11 may generate the block first among the nodes in the group, and the generated block may be delivered to other nodes.

When the first blockchain node 11 receives a block from another node while generating a block, it stops generating the block and waits for a verification result of the other node. When the block of the other node is verified, the first blockchain node 11 may discard the block being generated and generate the first blockchain using the verified block of the other node.

In addition, the first blockchain node 11 may verify the block generated by other nodes in the group.

The first blockchain node 11 may generate a comparison result by comparing the power production information and sales information of other nodes in the group with the block generated by other nodes in the group. In this case, the first blockchain node 11 may compare the power production information and sales information of other nodes in the group with the block generated by other nodes in the group, and may generate a comparison result according to whether each power production information and sales information match the power production information and sales information included in the block.

The first blockchain node 11 may verify the block by transmitting the comparison result to other nodes and collecting the comparison results of the nodes in the group. That is, the first blockchain node 11 may identify the number of nodes in the group that are concluded to be the same as the comparison result, and verify the block by determining whether the number exceeds at least 50% of the nodes in the group.

The first blockchain node 11 may update the first blockchain by linking the verified block to the previous first blockchain. In this case, the first blockchain node 11 may generate the first blockchain by sequentially collecting the blocks according to the generation time point.

In addition, the first blockchain node 11 may delete a block from the first blockchain after a certain time has elapsed. Through this, it is possible to secure the storage capacity on the system.

In addition, the first blockchain node 11 may guarantee the integrity of purchase information using the second blockchain. The process of verifying the integrity of purchase information will be described below.

The second blockchain node 12 may generate power purchase information and share it with nodes participating in the blockchain network.

The second blockchain node 12 may share the purchase information with all nodes participating in the blockchain network and store it in the second blockchain composed of blocks consented through the blockchain network.

In an embodiment, the second blockchain is a kind of method of storing data in logical sense, and may mean re-hashing a value of a previous access right information hashed by collecting hash values of previous access right information of the previous access right information and information for granting a new access right. In this case, a hash is generated to prevent forgery and falsification of contents to be stored, and when storing together with the hash, it may mean that the second blockchain has been generated.

In an embodiment, the server or system of a consumption company that wishes to participate in the RE100 energy transaction becomes the second blockchain node 12 that generates the second blockchain, and each node must be given credential with authorized access to the blockchain network.

Assuming that by comparing information on pre-shared and agreed upon access credentials for the node requesting an access to the blockchain network, a corresponding node has an access right (defined numbers or letters, not virtual currency), the access right may be stored in the second blockchain through a blockchain storage algorithm.

The block verification process is the final step in an access authorization process, and may refer to a process for verifying whether the content of the blockchain to which the access right generated from a specific node has been granted has been stored by other nodes in a device that has no facts of forgery and can be granted access.

The second blockchain is characterized by performing a series of processes of transaction, a proof of work, and incentive, and consecutive blocks generated in this process can be referred to as a blockchain. Blockchains can be stored in association with previous blocks, just as blocks are linked together.

Each second blockchain node 12 may periodically register its purchase information in the second blockchain. In an embodiment, the purchase information may include an owner of a consumption company, type of industry, type of business, production item, location, type and capacity of renewable energy to be purchased, desired purchase price, desired purchase time, and device information.

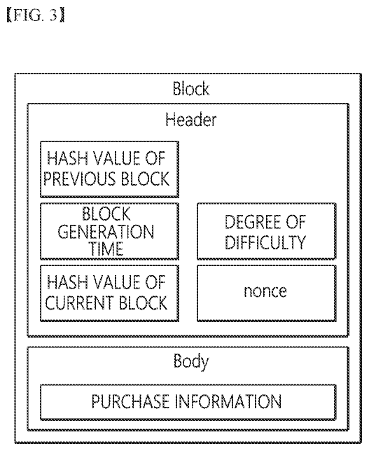

FIG. 3 illustrates a conceptual diagram of a second blockchain according to an embodiment. Referring to FIG. 3, the second blockchain may be divided into a header and a body. The header may include a hash value of a previous block, a block generation time, a degree of difficulty, a result value of a hash function for purchase information, and nonce information. The purchase information may be stored in the body.

In addition, the second blockchain node 12 may be periodically registered with the purchase information of each second blockchain node 12 and update the second blockchain.

In addition, the second blockchain node 12 may be periodically registered with the power production information and sales information of each first blockchain node 11 and update the first blockchain.

In addition, the second blockchain node 12 may update the first blockchain and the second blockchain using the registered information and provide it to all connected nodes. The second blockchain node 12 may provide the updated blockchain to other nodes in real time when the first blockchain or the second blockchain is updated.

The second blockchain node 12 may ensure the integrity of purchase information by using the second blockchain.

The second blockchain node 12 may transmit the purchase information to other nodes and store it in the second blockchain through the blockchain network. Through this, the purchase information may be synchronized for all nodes participating in the blockchain network. The synchronized details are verified by all nodes, and if there are no abnormalities, the block may be completed by consensus. In this case, the node participating to generate the second blockchain may mean all nodes in the blockchain network. Through these procedures, data is shared between nodes on a blockchain network, and transaction records are disclosed transparently, thereby guaranteeing the integrity of purchase information.

For example, the second blockchain node 12 may generate a block using the purchase information received from other nodes. The second blockchain node 12 may generate a block by combining the purchase information at a specific point in time into one block data.

The second blockchain node 12 may generate a block according to a previously set PoW. That is, the second blockchain node 12 collects the purchase information of the nodes in the group, applies PoW to the collected purchase information, and generates a block when the PoW is resolved. The block generation time is independent according to the difficulty of PoW and may be different depending on the block. That is, if a degree of difficulty of PoW is high, the block generation time may be delayed, and in this case, other nodes may generate the block first. Also, if the degree of difficulty of PoW is low, the second blockchain node 12 may generate the block first among the nodes in the group, and the generated block may be delivered to other nodes.

When the second blockchain node 12 receives a block from another node while generating a block, it stops generating the block and waits for a verification result of the other node. When the block of the other node is verified, the second blockchain node 12 may discard the block being generated and generate the second blockchain using the verified block of the other node.

In addition, the second blockchain node 12 may verify the block generated by other nodes in the group.

The second blockchain node 12 may generate a comparison result by comparing the purchase information of other nodes in the group with the block generated by other nodes in the group. In this case, the second blockchain node 12 may compare the purchase information of other nodes in the group with the block generated by other nodes in the group, and may generate a comparison result according to whether each power production information and sales information match the power production information and sales information included in the block.

The second blockchain node 12 may verify the block by transmitting the comparison result to other nodes and collecting the comparison results of the nodes in the group. That is, the second blockchain node 12 may identify the number of nodes in the group that are concluded to be the same as the comparison result, and verify the block by determining whether the number exceeds at least 50% of the nodes in the group.

The second blockchain node 12 may update the second blockchain by linking the verified block to the previous second blockchain. In this case, the second blockchain node 12 may generate the second blockchain by sequentially collecting the blocks according to the generation time point.

In addition, the second blockchain node 12 may delete a block from the second blockchain after a certain time has elapsed. Through this, it is possible to secure the storage capacity on the system.

In addition, the second blockchain node 12 may guarantee the integrity of power production information and sales information using the first blockchain. The process of verifying the integrity of power production information and sales information purchase information is the same as the verification process of the integrity of power production information and sales information of the first blockchain node 11, and duplicate descriptions will be omitted.

In addition, each of the first blockchain node 11 and the second blockchain node 12 stores the first blockchain for power production information and sales information and the second blockchain for power purchase information, and may update the first blockchain and the second blockchain when a renewable energy transaction occurs.

The first blockchain node 11 and the second blockchain node 12 may update the first blockchain and the second blockchain by generating transaction information when a renewable energy transaction occurs. In an embodiment, the transaction information may include purchase type of renewable energy, purchase amount, purchase meter and GPS location of a business, production time and purchase time.

The first blockchain node 11 and the second blockchain node 12 may receive transaction information between the first blockchain node 11 and the second blockchain node 12, and may update the first blockchain and the second blockchain. The first blockchain node 11 and the second blockchain node 12 may register transaction information in the first blockchain and the second blockchain when a renewable energy transaction occurs, and the first blockchain node 11 may update the first blockchain and the second blockchain using the transaction information. The first blockchain node 11 may update the first blockchain and the second blockchain by receiving corresponding transaction information even when a renewable energy transaction is made or when a transaction is not made.

The certification authority 13 may perform an authorization procedure of the first blockchain node 11 and second blockchain node 12 participating in the blockchain network.

In an embodiment, the certification authority 13 may refer to an institution that has public confidence capable of fairly managing and guaranteeing nodes and transactions, and can safely build and manage an authorization system. During the authorization process, the first blockchain node 11 and the second blockchain node 12 may generate a digital signature key pair, receive a digital signature verification key from the certification authority 13, and generate it in the form of a certificate. The generated certificate may include information on the owner of the digital signature key.

The certification authority 13 provides the digital signature verification key by users using information on the certification system, and may provide it according to a reliable method when there are various accredited certification service requests.

The certification authority 13 may issue credentials to a certified node.

A renewable energy generators and an RE100 consumption company obtain certification in advance from the certification authority 13 on whether or not they are legitimately qualified devices, including metering devices, and must obtain qualification as nodes to participate in the blockchain network of the RE100 energy transaction. If the RE100 energy transaction participant has obtained a normal qualification, the RE100 energy trading and tracking system may utilize a smart contract function to send the participant a credential to secure objective evidence related to the qualification to participate in the transaction.

The management server 14 may receive credentials from the certification authority 13 and manage nodes participating in the blockchain network. In an embodiment, the management server 14 is a third neutral institution, which may refer to, for example, the Korea Power Exchange.

In addition, the management server 14 may verify the reliability of the renewable energy transaction using stored node information when a renewable energy transaction occurs.

Basic information (owner, GPS location of a business, type of industry, type of business, device information, etc.) of accredited certificate nodes (producer, consumer) from the certification authority 13 is stored and managed in a database in the initial management server 14. This may verify the reliability of information by connecting to the management server 14 and comparing node information when necessary, such as generation of a blockchain of nodes or occurrence of a renewable energy transaction. In this case, whenever the basic information of the nodes is changed, the accredited certification from the certification authority 13 and the database of the management server 14 must be updated. By making this basic information into a database and comparing and verifying it only when necessary, the capacity, processing time and speed of the blockchain can be reduced.

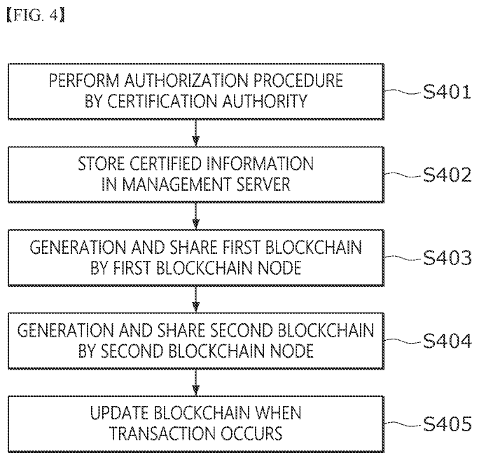

FIG. 4 illustrates a flowchart of a RE100 energy transaction method using a blockchain according to an embodiment.

Referring to FIG. 4, first, a certification authority performs an authorization procedure of the first blockchain node and second blockchain node participating in the blockchain network. The certification authority performs authorization of the first blockchain node, which is a power generator wishing to participate in an RE100 energy transaction, and the second blockchain node, which is a RE100 consumption company. The certification authority sends credentials to the certified node (S401).

Next, the information on the certified first and second blockchain nodes may be stored in the management server. The management server verifies the reliability of the transaction information by comparing it with the stored information whenever a renewable energy transaction is made (S402).

Next, the first blockchain node generates the first blockchain including power generation information and sales information according to the production of renewable energy and shares them with the nodes participating in the blockchain network (S403).

Meanwhile, the second blockchain node generates the first blockchain including power purchase information and shares it with the nodes participating in the blockchain network (S404).

Next, the first blockchain node and the second blockchain node update the first blockchain and the second blockchain when a renewable energy transaction occurs (S405).

In the RE100 energy transaction system using the blockchain according to an embodiment, the trading and tracking of the RE100 energy are largely divided into three stages: production/sales, purchase/consumption, and transaction conclusion, and producers and consumers (nodes) that want to participate in the RE100 energy transaction obtains device certification through a third method that can ensure reliability, and thus, only certified nodes can operate as blockchain nodes for renewable energy generators and consumers.

First, in the production/sales stage, a smart contract function is applied when a renewable energy generator enters various items into the RE100 energy trading and tracking system. When a power generator enters predefined transaction input conditions (information on the power generator, type of renewable energy, amount of energy produced, unit price, location, etc.) in the system, a transaction receipt is automatically issued to the power generator, and this receipt has public confidence. Therefore, it is possible to secure the reliability of whether or not the transaction reception was normally completed.

In addition, a verified block is added to an existing blockchain to prevent post-manipulation of the input production/sales information, and it is distributed and managed to a large number of participating nodes, so that even if some of the many nodes are hacked or forged, the remaining nodes keep the original information so that it is configured to prohibit the manipulation of production/sales information.

In the purchase/consumption stage, the smart contract function is applied when an RE100 consumption company enters various items into the RE100 energy trading and tracking system. When the RE100 consumption company enters predefined transaction input conditions (information on the consumption company, type of renewable energy to be purchased, amount of energy produced, unit price, location, etc.) in the system, a transaction receipt is automatically issued to the RE100 consumption company, and this receipt has public confidence. Therefore, it is possible to secure the reliability of whether or not the transaction reception was normally completed.

In addition, a verified block is added to an existing blockchain to prevent post-manipulation of the input desired purchase information, and it is distributed and managed to a large number of participating nodes, so that even if some of the many nodes are hacked or forged, the remaining nodes keep the original information so that it is configured to prohibit the manipulation of desired purchase information.

Lastly, in the transaction conclusion stage, when the production/sales information conditions and the desired purchase information conditions are met through the smart contract method between the power generator participant and the consumption company participant, the RE100 energy transaction is automatically concluded and the result is notified to the parties. This can be distributed and recorded on the distributed ledger of blockchain nodes to prevent forgery and tampering even when hacking occurs from the outside.

The method according to the embodiment may be implemented in the form of a program instruction executable by various computer means and stored in a computer-readable recording medium. The recording medium may continue to store a program executable by a computer or may temporarily store the program for execution or download. Furthermore, the recording medium may be various recording means or storage means of a form in which one or a plurality of pieces of hardware has been combined. The recording medium is not limited to a medium directly connected to a computer system, but may be one distributed over a network. An example of the recording medium may be one configured to store program instructions, including magnetic media such as a hard disk, a floppy disk and a magnetic tape, optical media such as CD-ROM and a DVD, magneto-optical media such as a floptical disk, ROM, RAM, and flash memory. Furthermore, other examples of the recording medium may include an app store in which apps are distributed, a site in which other various pieces of software are supplied or distributed, and recording media or storage media managed in a server.

The term “unit”, as used in the present embodiment means software or a hardware component, such as a field programmable gate array (FPGA) or an application-specific integrated circuit (ASIC), and the “unit” performs specific tasks. However, “unit” is not meant to be limited to software or hardware. The “unit” may be configured to reside on an addressable storage medium and configured to operate on one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operation on one or more CPUs within a device or a security multimedia card.

While the present invention has been described and illustrated herein with reference to the preferred embodiments thereof, it will be apparent to those skilled in the art that various modifications and variations can be made therein without departing from the spirit and scope of the invention.

1. An RE100 energy transaction system using a blockchain, comprising:
a first blockchain node that generates power production information and sales information according to production of renewable energy, and shares the power production information and the sales information with a node participating in a blockchain network;
a second blockchain node that generates power purchase information, and shares the power purchase information with the node participating in the blockchain network; and
a certification authority that performs an authentication procedure of the first and second blockchain nodes participating in the blockchain network,
wherein the first blockchain node and the second blockchain node store a first blockchain relating to the power production information and the sales information and a second blockchain relating to the power purchase information, respectively, and update the first blockchain and the second blockchain when a renewable energy transaction occurs.

2. The RE100 energy transaction system of claim 1, wherein the certification authority uses a blockchain that sends a credential to a certified node.

3. The RE100 energy transaction system of claim 2, further comprising a management server that receives the credential from the certification authority and manages the node participating in the blockchain network.

4. The RE100 energy transaction system of claim 3, wherein the management server verifies reliability of the renewable energy transaction using stored node information when the renewable energy transaction occurs.

5. The RE100 energy transaction system of claim 1, wherein the power production information and the sales information include an owner of a power generator, type of industry, location, type of production energy, total capacity available for production, current production and sales capacity and unit price, production time, production energy power information and grid connection information.

6. The RE100 energy transaction system of claim 1, wherein the purchase information includes an owner of a consumption company, type of industry, type of business, production item, location, type and capacity of renewable energy to be purchased, desired purchase price, desired purchase time, and device information.

7. The RE100 energy transaction system of claim 1, wherein the first blockchain node and the second blockchain node generate transaction information when the renewable energy transaction occurs to update the first blockchain and the second blockchain.

8. The RE100 energy transaction system of claim 7, wherein the transaction information includes purchase type of renewable energy, purchase amount, purchase meter and GPS location of a business, production time and purchase time.

9. An RE100 energy transaction method using a blockchain, comprising:
performing, by a certification authority, an authorization procedure of first and second blockchain nodes participating in a blockchain node;
generating power production information and sales information according to production of renewable energy and sharing the power production information and the sales information with a node participating in the blockchain network by the first blockchain node;
generating power purchase information and sharing the power purchase information with the node participating in the blockchain network by the second blockchain node; and
updating the first blockchain node and the second blockchain node by the first blockchain node and the second blockchain node when a renewable energy transaction occurs.

10. The RE100 energy transaction method of claim 9, wherein the certification authority uses a blockchain that sends a credential to a certified node.

11. The RE100 energy transaction method of claim 10, further comprising receiving the credential from the certification authority and managing the node participating in the blockchain network by a management server.

12. The RE100 energy transaction method of claim 11, further comprising verifying, by the management server, reliability of the renewable energy transaction using stored node information when the renewable energy transaction occurs.

13. The RE100 energy transaction method of claim 9, wherein the power production information and the sales information include an owner of a power generator, type of industry, location, type of production energy, total capacity available for production, current production and sales capacity and unit price, production time, production energy power information and grid connection information.

14. The RE100 energy transaction method of claim 9, wherein the purchase information includes an owner of a consumption company, type of industry, type of business, production item, location, type and capacity of renewable energy to be purchased, desired purchase price, desired purchase time, and device information.

15. The RE100 energy transaction method of claim 9, wherein the first blockchain node and the second blockchain node generate transaction information when the renewable energy transaction occurs to update the first blockchain and the second blockchain.

16. The RE100 energy transaction method of claim 15, wherein the transaction information includes purchase type of renewable energy, purchase amount, purchase meter and GPS location of a business, production time and purchase time.

17. A computer-readable storage medium storing a program that, when executed by a computer, causes the computer to perform the method of claim 9.
